(19) United States
(12) Patent Application Publication
(10) Pub. No.: US 2023/0117772 A1
(43) Pub. Date: Apr. 20, 2023

(54) VEHICLE MAINTENANCE SYSTEM

(71) Applicant: TOYOTA JIDOSHA KABUSHIKI KAISHA, Toyota-shi (JP)

(72) Inventor: Tomokazu AKUTSU, Nagakute-shi (JP)

(73) Assignee: TOYOTA JIDOSHA KABUSHIKI KAISHA, Toyota-shi (JP)

(21) Appl. No.: 17/894,560

(22) Filed: Aug. 24, 2022

(30) Foreign Application Priority Data
Oct. 19, 2021 (JP) 2021-170973

(51) Int. Cl. G07C 5/00; G07C 5/08; G07C 5/04; F01N 11/00

(52) U.S. Cl. CPC G07C 5/006; G07C 5/0808; G07C 5/04; F01N 11/00; F01N 2550/04

(57) ABSTRACT

A maintenance system includes a processing circuit that executes a calculation process for calculating recommended execution time of a regeneration process. The processing circuit of the maintenance system also executes a display process for displaying the calculated recommended execution time. The processing circuit executes an analysis process for analyzing a usage mode of a vehicle based on history information of travel data. The processing circuit refers to an analysis result of the analysis process in the calculation process. When the analysis result of the analysis process indicates a usage mode in which overaccumulation is unlikely to recur, the processing circuit calculates the recommended execution time shorter than when the analysis result does not indicate the usage mode in which the overaccumulation is unlikely to recur.

### CROSS-REFERENCE TO RELATED APPLICATION

This application claims priority to Japanese Patent Application No. 2021-170973 filed on Oct. 19, 2021, incorporated herein by reference in its entirety.

### BACKGROUND

### 1. Technical Field

The present disclosure relates to a vehicle maintenance system.

### 2. Description of Related Art

A particulate filter is provided in an exhaust passage of an engine mounted on a vehicle. The particulate filter collects particulate matter contained in the exhaust gas. Japanese Unexamined Patent Application Publication No. 2005-291036 (JP 2005-291036 A) discloses that a regeneration process for combusting and removing particulate matter to regenerate a particulate filter is performed at a maintenance shop or the like of a dealer.

A regeneration processing device disclosed in JP 2005-291036 A calculates an accumulated amount that is an amount of particulate matter accumulated on the particulate filter. Then, maximum time of the regeneration process is set according to the accumulated amount. The regeneration processing device stops the regeneration process when the elapsed time from the start of the regeneration process reaches the maximum time. Further, the regeneration processing device stops the regeneration process by determining that the regeneration is completed when the accumulated amount becomes equal to or less than a determination value.

### SUMMARY

It takes a certain amount of time to execute the regeneration process until the accumulated amount becomes equal to or less than a determination value or the elapsed time reaches the maximum time. Therefore, a user of a vehicle will be kept waiting for a long time. In addition, the restraint time of a worker becomes long.

Hereinafter, means for solving the above issue and its operations and effects will be described.

A vehicle maintenance system for solving the above issue is a vehicle maintenance system for a vehicle including a function for determining overaccumulation when an accumulated amount of particulate matter in a particulate filter provided in an exhaust passage of an engine becomes equal to or larger than a predetermined amount and encouraging a user to maintain the vehicle to eliminate a state of the overaccumulation. This vehicle maintenance system includes a processing circuit for executing an acquisition process for acquiring travel data of the vehicle, a calculation process for calculating recommended execution time of a regeneration process to be executed as maintenance, and a display process for displaying the calculated recommended execution time. In this maintenance system, the processing circuit executes an analysis process for analyzing a usage mode of the vehicle based on history information of the travel data acquired through the acquisition process. Then, in the calculation process, the processing circuit refers to an analysis result of the analysis process, and when the analysis result indicates a usage mode in which the overaccumulation is unlikely to recur, the processing circuit calculates the recommended execution time shorter than when the analysis result does not indicate the usage mode in which the overaccumulation is unlikely to recur.

The particulate matter accumulated on the particulate filter combusts not only during the regeneration process performed at a maintenance shop, but also during traveling of the vehicle by the user when a condition for combusting the particulate matter is satisfied. However, depending on the usage mode of the vehicle, there are few opportunities for the vehicle to travel in a state where the condition for combusting the particulate matter is satisfied, and the particulate matter does not combust. On the other hand, in a usage mode in which the vehicle easily travels in a state where the condition for combusting the particulate matter is satisfied, the particulate matter combusts during traveling of the vehicle. That is, the usage mode in which the vehicle easily travels in a state where the condition for combusting the particulate matter is satisfied is a usage mode in which the overaccumulation is unlikely to recur.

When the vehicle is used in the usage mode in which the overaccumulation is unlikely to recur, the particulate matter is removed as the particulate matter combusts along with traveling of the vehicle even when the regeneration process is terminated in a state where the particulate matter remains in the particulate filter.

In the above maintenance system, the recommended execution time is reduced when the analysis result based on the history information of the travel data indicates the usage mode in which the overaccumulation is unlikely to recur. When the recommended execution time is calculated as described above based on the history information of the travel data, the execution time of the regeneration process can be reduced in consideration of the decrease in the particulate matter after the maintenance.

According to one aspect of the vehicle maintenance system, in the analysis process, the processing circuit calculates index values of recurrence risk of the overaccumulation for each trip based on the history information of the travel data, and when an average value of the index values is less than a threshold value, the processing circuit outputs the analysis result indicating the usage mode in which the overaccumulation is unlikely to recur.

As in the above configuration, a configuration is adopted in which the index value for each trip is calculated, and when the average value of the calculated multiple index values is less than the threshold value, it is determined as the usage mode in which the overaccumulation is unlikely to recur, so that the analysis process can be realized.

According to one aspect of the vehicle maintenance system, in the analysis process, the processing circuit calculates index values of recurrence risk of the overaccumulation for each trip based on the history information of the travel data, and outputs an average value of the index values as the analysis result. Then, in the calculation process, the processing circuit calculates the recommended execution time that is shorter as the average value is small.

As in the above configuration, a configuration is adopted in which the index value for each trip is calculated, and it is determined as the usage mode in which overaccumulation is unlikely to recur as the average value of the calculated multiple index values is small, so that the analysis process can be realized. Further, in this case, as in the above configuration, the shorter recommended execution time is calculated as the average value is small. As a result, the execution time of the regeneration process can be reduced according to unlikelihood of recurrence of the overaccumulation.

According to one aspect of the vehicle maintenance system, the travel data includes mileage for one trip. Then, the processing circuit calculates, in the analysis process, a value larger than when the mileage is equal to or more than a predetermined distance as an index value, when the mileage is less than the predetermined distance.

When the engine and a catalyst device installed in the exhaust passage are not sufficiently warmed up and travel of the vehicle is completed, the vehicle does not travel in a state where a condition for combusting the particulate matter is satisfied. As a result, the particulate matter accumulated on the particulate filter does not combust. On the other hand, when the mileage for one trip is long, opportunity for the vehicle to travel in a state where the engine and the catalyst device are sufficiently warmed up is increased. Therefore, the particulate matter is likely to combust during traveling of the vehicle. That is, when the mileage for one trip is long, it can be said that the recurrence risk of the overaccumulation is low. On the contrary, when the mileage for one trip is short, it can be said that the recurrence risk of the overaccumulation is high.

Therefore, when a configuration is adopted in which when the mileage is less than the predetermined distance as in the above configuration, a value larger than when the mileage is equal to or greater than the predetermined distance is calculated as the index value, the recurrence risk of the overaccumulation can be set as an index.

According to one aspect of the vehicle maintenance system, the travel data includes an average vehicle speed for one trip. Then, the processing circuit calculates, in the analysis process, a value larger than when the average vehicle speed is equal to or higher than a predetermined vehicle speed as an index value, when the average vehicle speed is less than the predetermined vehicle speed.

The engine is likely to be operated with a high load as the vehicle speed is high. When the engine is operated with a high load, the temperature of the exhaust gas is high, so that the temperature of the particulate filter and the temperature of the catalyst device are high. Therefore, the particulate matter accumulated on the particulate filter easily combusts. That is, when the average vehicle speed for one trip is high, it can be said that the recurrence risk of the overaccumulation is low. On the contrary, when the average vehicle speed for one trip is low, it can be said that the recurrence risk of the overaccumulation is high.

Therefore, when a configuration is adopted in which when the average vehicle speed is less than the predetermined vehicle speed as in the above configuration, a value larger than when the average vehicle speed is equal to or higher than the predetermined vehicle speed is calculated as the index value, the recurrence risk of the overaccumulation can be set as an index.

According to one aspect of the vehicle maintenance system, the travel data includes an average temperature of the particulate filter for one trip. Then, the processing circuit calculates, in the analysis process, a value larger than when the average temperature is equal to or higher than a predetermined temperature as an index value, when the average temperature is less than the predetermined temperature.

The particulate matter easily combusts as the temperature of the particulate filter is high. Further, the more the particulate matter combusts during traveling of the vehicle, the higher the temperature of the particulate filter becomes. That is, when the average temperature of the particulate filter for one trip is high, it can be said that the recurrence risk of the overaccumulation is low. On the contrary, when the average temperature for one trip is low, it can be said that the recurrence risk of the overaccumulation is high.

Therefore, when a configuration is adopted in which when the average temperature of the particulate filter is less than the predetermined temperature as in the above configuration, a value larger than when the average temperature is equal to or higher than the predetermined temperature is calculated as the index value, the recurrence risk of the overaccumulation can be set as an index.

According to one aspect of the vehicle maintenance system, the travel data includes a coolant temperature when the engine is started. Then, the processing circuit calculates, in the analysis process, a value larger than when the coolant temperature is equal to or higher than a predetermined coolant temperature as an index value, when the coolant temperature is less than the predetermined coolant temperature.

The engine is started from a state close to a state in which the warm-up of the engine is completed, as the coolant temperature at the time of starting the engine is high, so that opportunity for vehicle to travel in a state where the warm-up of the engine is completed tends to increase. Further, the higher the coolant temperature at the time of starting the engine, the higher the possibility that the next trip is started before the engine is completely cooled and the vehicle travels in a state where the warm-up of the engine is completed.

The more frequently the vehicle travels in a state in which the warm-up is completed, the more easily the particulate matter combusts during traveling of the vehicle. That is, when the coolant temperature at the time of starting the engine is high, it can be said that the recurrence risk of the overaccumulation is low. On the contrary, when the coolant temperature at the time of starting the engine is low, it can be said that the recurrence risk of the overaccumulation is high.

Therefore, when a configuration is adopted in which when the coolant temperature at the time of starting the engine is less than the predetermined coolant temperature as in the above configuration, a value larger than when the coolant temperature is equal to or higher than the predetermined coolant temperature is calculated as the index value, the recurrence risk of the overaccumulation can be set as an index.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a relationship between a data center, a vehicle to be maintained, and an information processing terminal, which are an embodiment of a maintenance system;

FIG. 2 is a schematic diagram showing a configuration of the vehicle to be maintained;

FIG. 3 is a flowchart showing a flow of a series of processes in a routine executed by a processing circuit of the data center;

FIG. 4 is an explanatory diagram showing a relationship between a score of an accumulation risk used for calculating an index value of a recurrence risk of overaccumulation and an average vehicle speed and mileage for one trip; and

FIG. 5 is a time chart showing a transition in a change of an accumulated amount of particulate matter by a regeneration process.

### DETAILED DESCRIPTION OF EMBODIMENTS

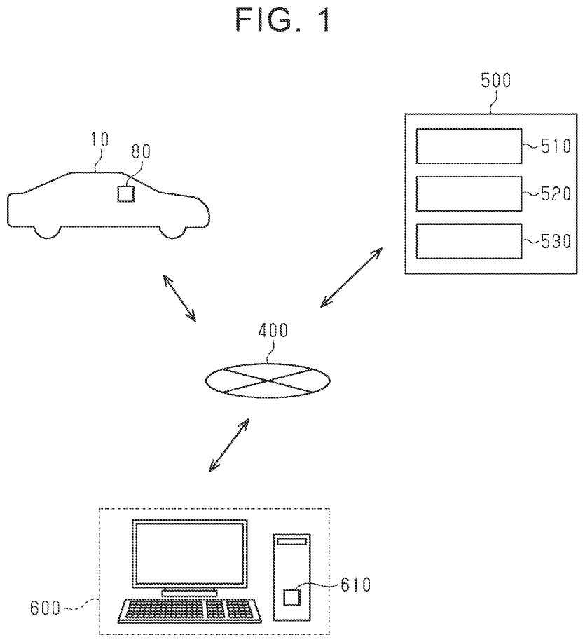

Hereinafter, an embodiment of a vehicle maintenance system will be described with reference to FIGS. 1 to 5.

### Configuration of Maintenance System

FIG. 1 shows a configuration of a network including a data center 500 that is a maintenance system according to the embodiment. As shown in FIG. 1, the data center 500 communicates with an information processing terminal 600 provided in a maintenance shop and a vehicle 10 via a communication network 400.

Configuration of Information Processing Terminal 600

The maintenance shop is a shop that repairs, maintains, and inspects the vehicle 10, and is, for example, a maintenance shop of a dealer who has sold the vehicle 10. The information processing terminal 600 provided in the maintenance shop is, for example, a personal computer and includes a display for displaying information. The information processing terminal 600 may be a smartphone or a tablet terminal. Further, the information processing terminal 600 includes a communication device 610. The communication device 610 is implemented as hardware such as a network adapter, various kinds of communication software, or a combination thereof. The communication device 610 is configured to be able to realize wired or wireless communication via the communication network 400.

Configuration of Data Center 500

As shown in FIG. 1, the data center 500 includes a storage device 520 in which a program is stored and a processing circuit 510 that executes a program stored in the storage device 520 to execute various processes. Further, the data center 500 includes a communication device 530. The communication device 530 is also implemented as hardware such as a network adapter, various kinds of communication software, or a combination thereof. The communication device 530 is configured to be able to realize wired or wireless communication via the communication network 400.

The data center 500 can be configured using multiple computers. For example, the data center 500 can be composed of multiple server devices.

The data center 500 configured as described above has functions as a web server and an application server. The processing circuit 510 executes various processes in response to a request from a web browser or other applications installed in the information processing terminal 600. As a result, the processing circuit 510 transmits screen data, control data, and the like according to a result of the process to the information processing terminal 600. The screen data is, for example, hypertext markup language (HTML) data. The information processing terminal 600 displays a web page or other application screens based on the data received from the data center 500.

The information processing terminal 600 can exchange information on maintenance of the vehicle 10 by executing communication with the data center 500 via the web browser or other applications.

Configuration of Vehicle 10

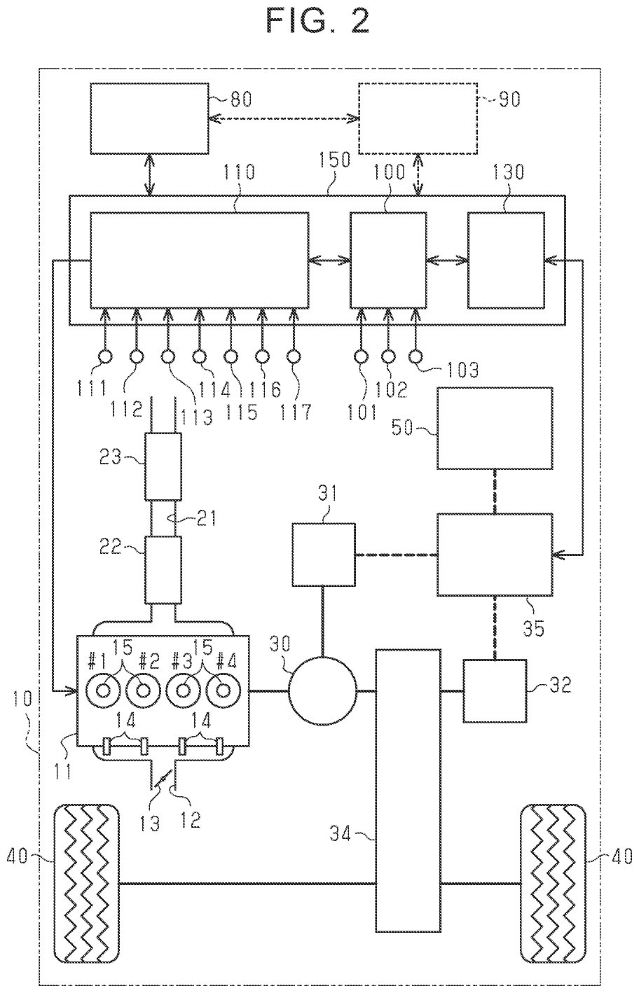

As shown in FIG. 2, the vehicle 10 includes an engine 11 and a second motor generator 32 as a power source. That is, the vehicle 10 is a hybrid electric vehicle.

The engine 11 includes an intake passage 12 and an exhaust passage 21. In an example shown in FIG. 2, the engine 11 includes four cylinders. The intake passage 12 is provided with a throttle valve 13 for adjusting the flow rate of the intake air flowing through the intake passage 12. The engine 11 is provided with multiple injectors 14 for injecting fuel while the engine 11 takes in the air, one of which being provided for each cylinder. The multiple injectors 14 may be provided for each cylinder, or the number of injectors 14 provided for each cylinder may be different from each other. Further, the engine 11 is provided with multiple spark plugs 15 for igniting an air-fuel mixture of fuel and intake air by spark discharge, one of which being provided for each cylinder. The multiple spark plugs 15 may be provided for each cylinder, or the number of spark plugs 15 provided for each cylinder may be different from each other.

An upstream exhaust gas control device 22 and a downstream exhaust gas control device 23 are installed in the exhaust passage 21 of the engine 11. The downstream exhaust gas control device 23 is provided on the downstream side of the upstream exhaust gas control device 22 in the exhaust passage 21. The upstream exhaust gas control device 22 is a nitrogen oxides (NOx) storage type three-way catalyst. Further, the downstream exhaust gas control device 23 carries a three-way catalyst on a particulate filter that collects particulate matter in the exhaust gas.

A second motor generator 32 is connected to a battery 50 via a power control unit 35. The second motor generator 32 is connected to drive wheels 40 via a reduction mechanism 34.

Further, the engine 11 is connected to the drive wheels 40 via a power split mechanism 30 and the reduction mechanism 34. A first motor generator 31 is also connected to the power split mechanism 30. The first motor generator 31 is, for example, a three-phase alternating current type motor generator. The power split mechanism 30 is a planetary gear mechanism, and can split the driving force of the engine 11 into the first motor generator 31 and the drive wheels 40.

The first motor generator 31 receives the driving force of the engine 11 and the driving force from the drive wheels 40 to generate electric power. The first motor generator 31 also serves as a starter for driving a crankshaft that is an output shaft of the engine 11, when the engine 11 is started. At that time, the first motor generator 31 functions as a motor for generating the driving force according to the supply of electric power from the battery 50.

The first motor generator 31 and the second motor generator 32 are connected to the battery 50 via the power control unit 35. The alternating current power generated by the first motor generator 31 is converted into the direct current by the power control unit 35 and charged into the battery 50. That is, the power control unit 35 functions as an inverter.

Further, the direct current power of the battery 50 is converted into the alternating current by the power control unit 35 and supplied to the second motor generator 32. When the vehicle 10 is decelerated, the second motor generator 32 generates electric power using the driving force from the drive wheels 40. Then, the generated electric power is charged into the battery 50. That is, in the vehicle 10, regenerative charging is performed. In this case, the second motor generator 32 functions as a generator. The alternating current power generated by the second motor generator 32 is converted into the direct current by the power control unit 35 and charged into the battery 50.

When the first motor generator 31 functions as the starter, the power control unit 35 converts the direct current power of the battery 50 into the alternating current and supplies this to the first motor generator 31.

Control Device 150

A control device 150 controls the engine 11, the first motor generator 31, and the second motor generator 32. The control device 150 includes an engine control unit 110 that controls the engine 11. Further, the control device 150 includes a motor control unit 130 that controls the power control unit 35 to control the first motor generator 31 and the second motor generator 32. Further, the control device 150 includes a vehicle control unit 100 that is connected to the engine control unit 110 and the motor control unit 130 and administers the control of the vehicle 10. Each of these control units is composed of a processing circuit and a memory that stores a program or the like executed by the processing circuit.

The control device 150 controls the engine 11, the first motor generator 31, and the second motor generator 32. That is, the control device 150 controls the power train of the vehicle 10. A detection signal of a sensor provided in each part of the vehicle 10 is input to the control device 150.

Specifically, an accelerator position sensor 101, a brake sensor 102, and a vehicle speed sensor 103 are connected to the vehicle control unit 100. The accelerator position sensor 101 detects an accelerator operation amount. The brake sensor 102 detects an operation amount of a brake. The vehicle speed sensor 103 detects a vehicle speed that is a speed of the vehicle 10.

A crank position sensor 111 and a coolant temperature sensor 112 are connected to the engine control unit 110. The crank position sensor 111 outputs a crank angle signal each time the crankshaft rotates by a certain angle. The engine control unit 110 calculates, based on the crank angle signal, the rotation phase of the crankshaft and the engine rotation speed NE that is the rotation speed of the crankshaft. The coolant temperature sensor 112 detects the coolant temperature that is the temperature of a coolant of the engine 11.

An upstream air-fuel ratio sensor 113 is provided on the upstream side of the upstream exhaust gas control device 22 in the exhaust passage 21. The upstream air-fuel ratio sensor 113 is connected to the engine control unit 110. The upstream air-fuel ratio sensor 113 detects the air-fuel ratio of the exhaust gas introduced into the upstream exhaust gas control device 22.

A downstream air-fuel ratio sensor 114 is disposed in a portion of the exhaust passage 21 that is on the downstream side of the upstream exhaust gas control device 22 and on the upstream side of the downstream exhaust gas control device 23. The downstream air-fuel ratio sensor 114 is also connected to the engine control unit 110. The downstream air-fuel ratio sensor 114 detects the air-fuel ratio of the exhaust gas that has passed through the upstream exhaust gas control device 22.

Then, a differential pressure sensor 115 that detects the differential pressure between the exhaust gas pressure of the portion of the exhaust passage 21 between the upstream exhaust gas control device 22 and the downstream exhaust gas control device 23 and the exhaust gas pressure of the portion on the downstream side of the downstream exhaust gas control device 23 is connected to the engine control unit 110.

Further, an upstream temperature sensor 116 that detects the temperature of the upstream exhaust gas control device 22 and a downstream temperature sensor 117 that detects the temperature of the downstream exhaust gas control device 23 are connected to the engine control unit 110.

Further, the current, the voltage and the temperature of the battery 50 are input to the motor control unit 130 via the power control unit 35. The motor control unit 130 calculates a charge state index value SOC that is the ratio of the remaining charge to the charge capacity of the battery 50, based on the current, the voltage, and the temperature of the battery 50.

The engine control unit 110 and the motor control unit 130 are each connected to the vehicle control unit 100 by a communication line. Then, each of these control units exchanges and shares information based on the detection signal input from the sensor by controller area network (CAN) communication and the calculated information.

Control of Vehicle 10

The vehicle 10 configured as described above uses the electric power stored in the battery 50 to drive the second motor generator 32, whereby the vehicle 10 can travel by driving a motor in which the drive wheels 40 are driven using only the second motor generator 32. Further, the vehicle 10 can travel by driving both a motor and an engine in which the drive wheels 40 are driven using the engine 11 and the second motor generator 32.

The vehicle control unit 100 outputs the required power and the required engine rotation speed of the engine 11 to the engine control unit 110 based on the accelerator operation amount, the operation amount of the brake, the vehicle speed, and the charge state index value SOC. Further, the required torque and the target number of rotations for each of the first motor generator 31 and the second motor generator 32 are output to the motor control unit 130.

The engine control unit 110 controls the engine 11 so as to realize the required power and the required engine rotation speed. The engine control unit 110 basically executes fuel injection control such that the air-fuel ratio in each cylinder of the engine 11 becomes the stoichiometric air-fuel ratio. Further, fuel injection and ignition in the engine 11 are executed in the order of a first cylinder #1, a third cylinder #3, a fourth cylinder #4, and a second cylinder #2.

The motor control unit 130 controls the first motor generator 31 and the second motor generator 32 so as to realize the required torque and the target number of rotations.

### Regeneration Process of Particulate Filter

As described above, the vehicle 10 includes the downstream exhaust gas control device 23 that carries the three-way catalyst on the particulate filter. The accumulated amount of the particulate matter on the particulate filter increases as the mileage of the vehicle 10 increases. The accumulated amount tends to increase as the environmental temperature is low.

In the vehicle 10, it is necessary to execute a regeneration process for combusting the accumulated particulate matter to restore the function of the particulate filter. In this vehicle 10, oxygen is sent to the particulate filter in a state where the temperature of the particulate filter is sufficiently raised, so that the particulate matter accumulated on the particulate filter is combusted.

Stop Control

In the vehicle 10, the temperature of the particulate filter of the downstream exhaust gas control device 23 is raised as described above, and the accumulated particulate matter is combusted to regenerate the particulate filter. In the vehicle 10, the fuel supply in any of the four cylinders of the engine 11 is stopped, and the crankshaft is rotated by the torque generated by the combustion of the fuel in the other cylinders. Then, the air is sent to the exhaust passage 21 from the stop cylinder in which the fuel supply is stopped. Hereinafter, such control is referred to as stop control. During the stop control, the fuel supply amount to the cylinders other than the stop cylinder is increased, and the surplus fuel is supplied to the exhaust passage 21 through the cylinders other than the stop cylinder.

By the stop control, the air that has passed through the stop cylinder and the surplus fuel supplied to the cylinders other than the stop cylinder are introduced into the upstream exhaust gas control device 22 and the downstream exhaust gas control device 23. As a result, the fuel is oxidized by the action of the three-way catalyst in the upstream exhaust gas control device 22. Then, the temperature of the particulate filter rises when the exhaust gas warmed by the reaction heat is introduced into the downstream exhaust gas control device 23. As a result, the particulate matter accumulated on the particulate filter is combusted and the particulate filter is regenerated.

In the vehicle 10, the regeneration process by the stop control described above is executed when an execution condition during traveling of the vehicle is satisfied. The execution condition is, for example, a logical conjunction condition that the warm-up of the engine 11 is completed, the temperature of the upstream exhaust gas control device 22 and the temperature of the downstream exhaust gas control device 23 are equal to or higher than a certain temperature, and the like.

Further, in the vehicle 10, the engine control unit 110 calculates the accumulated amount of the particulate matter on the particulate filter. Specifically, the engine control unit 110 calculates the accumulated amount based on the differential pressure detected by the differential pressure sensor 115. The differential pressure becomes great as the accumulated amount of the particulate matter on the particulate filter is large. Therefore, the engine control unit 110 calculates a larger value as the accumulated amount as the differential pressure is great. The accumulated amount may be calculated by the estimation of the generated amount and the combustion amount of the particulate matter based on the information such as the fuel injection amount, the air-fuel ratio, and the engine rotation speed NE.

When the stop control is executed, energy by the combustion is not generated in the stop cylinder, so that the output torque of the engine 11 fluctuates periodically. In the vehicle 10, in order to suppress fluctuation during the stop control described above, the second motor generator 32 is driven to execute torque compensation control for compensating for the torque shortage for the stop cylinder.

By the way, the above regeneration process during traveling of the vehicle cannot be executed unless the condition for combusting the particulate matter is satisfied. Therefore, when the vehicle 10 repeatedly travels and stops while the engine 11 is not completely warmed up because the very short-distance travel and stop of the vehicle 10 are repeated, the regeneration process is rarely executed. As a result, the accumulated amount of the particulate matter continues to increase. In addition, when the short-distance travel is repeated in a state where the environmental temperature is extremely low, the accumulated amount of the particulate matter tends to increase.

In the vehicle 10, when the accumulated amount of the particulate matter becomes equal to or more than a predetermined amount, it is determined as overaccumulation, and information for encouraging a user to maintain the vehicle for eliminating the state of the overaccumulation is displayed on a display of a driver's seat. The information continues to be displayed until a flag indicating the state of the overaccumulation is released when the regeneration process as maintenance for eliminating the state of the overaccumulation is executed at a maintenance shop, etc., and the regeneration process as maintenance is completed. Therefore, the user of the vehicle 10 brings the vehicle 10 to the maintenance shop and the vehicle 10 undergoes maintenance when the accumulated amount of the particulate matter is determined as the overaccumulation and this information is displayed.

Regeneration Process as Maintenance

When the vehicle 10 determined as the overaccumulation is brought to the maintenance shop, a worker at the maintenance shop combusts the particulate matter accumulated on the particulate filter and executes the regeneration process as maintenance to restore the function of the particulate filter.

The regeneration process executed as maintenance here is a vehicle stop regeneration process in which the particulate matter accumulated on the particulate filter is combusted while the vehicle stops, and the engine 11 is operated such that the particulate matter accumulated on the particulate filter is removed. For example, in the vehicle stop regeneration process, the above stop control is executed while the vehicle stops. As a result, the temperature of the particulate filter is raised and oxygen is supplied to combust the particulate matter.

Calculation of Recommended Execution Time Tm

By the way, it takes a certain amount of time to execute the vehicle stop regeneration process from the state where the accumulated amount is so large that it is determined as the overaccumulation until the particulate matter accumulated on the particulate filter is almost completely removed. Therefore, the user of the vehicle 10 will be kept waiting for a long time. In addition, the restraint time of the worker becomes long.

Therefore, the data center 500, which is the maintenance system, analyzes a usage mode of the vehicle 10 based on history information of travel data of the vehicle 10. Then, the data center 500 calculates recommended execution time Tm according to the usage mode of the vehicle 10. The data center 500 transmits information on the calculated recommended execution time Tm to the information processing terminal 600 of the maintenance shop and displays this on the display. In this maintenance system, the recommended execution time Tm is displayed as described above such that the worker executes the vehicle stop regeneration process with reference to the recommended execution time Tm. As a result, the vehicle stop regeneration process is executed at a length suitable for the usage mode of the vehicle 10.

As shown in FIGS. 1 and 2, the vehicle 10 is provided with a communication device 80. The communication device 80 is also implemented as hardware such as a network adapter, various kinds of communication software, or a combination thereof. The communication device 80 is configured to be able to realize wired or wireless communication via the communication network 400.

The travel data is transmitted from the vehicle 10 to the data center 500 by the communication device 80. For example, for each trip, the travel data including the mileage and the average vehicle speed of the vehicle 10 for one trip is transmitted to the data center 500. Identification information that identifies the vehicle 10 is also transmitted to the data center 500 together with the travel data. When the data center 500 receives the travel data together with the identification information, the data center 500 stores the received data in the storage device 520. The travel data of the vehicle 10 is stored in the storage device 520 of the data center 500 as described above.

The one trip is a period from when a main switch of the vehicle 10 is turned on and the system is started until the main switch of the vehicle 10 is turned off and the system is stopped.

When the vehicle 10 that requires the vehicle stop regeneration process enters a parking space, the worker at the maintenance shop operates the information processing terminal 600 and requests the data center 500 to calculate the recommended execution time Tm of the vehicle stop regeneration process for the vehicle 10. At this time, the identification information that identifies the vehicle 10 is also transmitted to the data center 500. Upon receiving this request, the data center 500 reads the history information of the travel data of the vehicle 10 from the storage device 520 in response to the request. Then, an analysis process for analyzing the usage mode of the vehicle 10 is executed based on the history information. The data center 500 executes a calculation process for calculating the recommended execution time Tm of the vehicle stop regeneration process for the vehicle 10 based on the analysis result of the analysis process. Finally, the data center 500 transmits the information on the calculated recommended execution time Tm to the information processing terminal 600, and displays the recommended execution time Tm on the display of the information processing terminal 600.

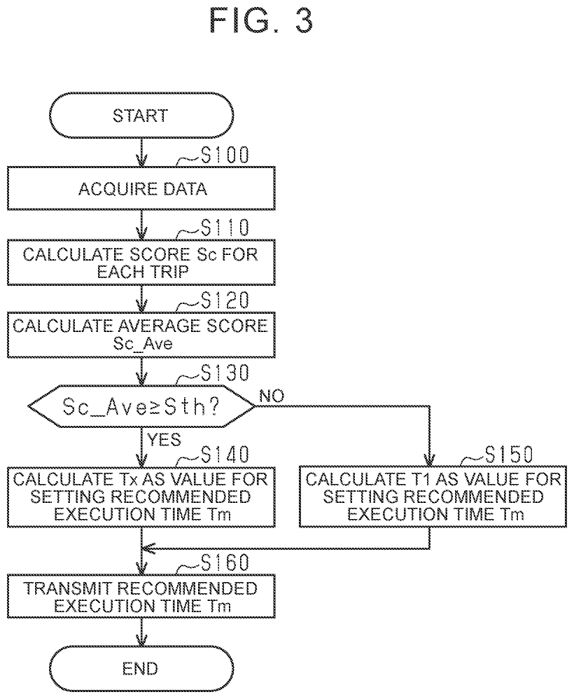

Next, with reference to FIG. 3, a flow of a series of processes executed by the data center 500 when the calculation of the recommended execution time Tm is requested will be described.

The routine shown in FIG. 3 is executed by the processing circuit 510 of the data center 500 when a signal requesting the calculation of the recommended execution time Tm is received.

As shown in FIG. 3, when this routine is started, the processing circuit 510 first reads and acquires the history information of the travel data of the vehicle 10 stored in the storage device 520 in the process of step S100. The process of step S100 is an acquisition process. The processing circuit 510 identifies the vehicle 10 to be analyzed based on the received identification information. Then, the history information of the travel data of the target vehicle 10 is acquired from the storage device 520. In this maintenance system, data of the mileage and the average vehicle speed for one trip is acquired. Here, the history information in the period from the time when the regeneration process as maintenance was executed for the target vehicle 10 previous time to the time when the accumulated amount is determined as the overaccumulation this time is acquired.

In the process of next step S110, the processing circuit 510 calculates a score Sc for each trip based on the travel data acquired through the process of step S100. The score Sc is an index value of a recurrence risk of the overaccumulation. For example, when it is estimated that the accumulated amount of the particulate matter is likely to increase based on the travel data, the recurrence risk is high and the score Sc is set to a large value. On the other hand, when it is estimated that the accumulated amount of the particulate matter is likely to decrease based on the travel data, the recurrence risk is low and the score Sc is set to a small value.

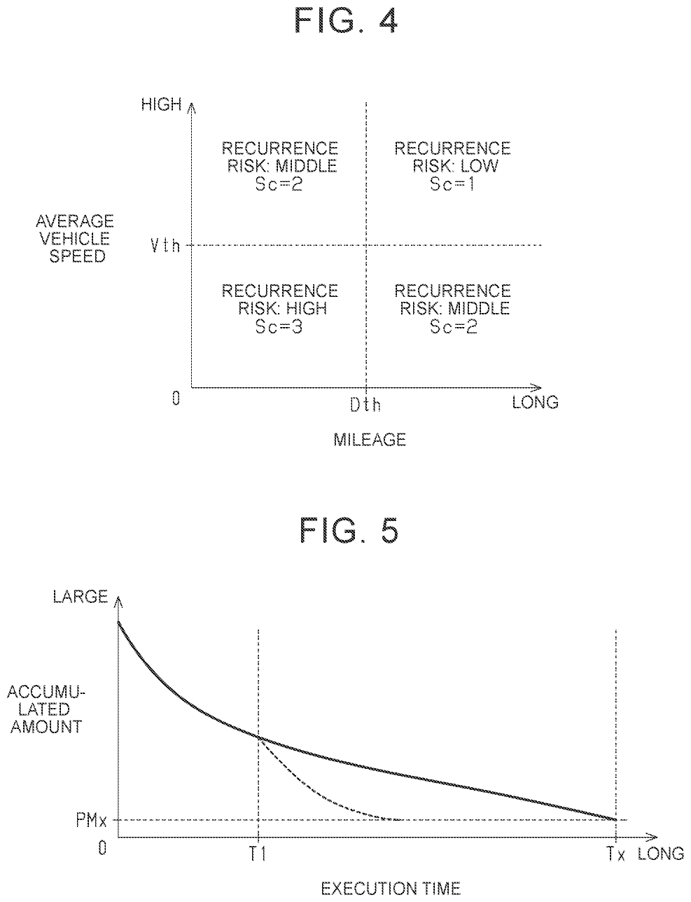

Specifically, as shown in FIG. 4, the processing circuit 510 calculates the score Sc for each trip based on the average vehicle speed and the mileage for each trip. When the mileage is less than a predetermined distance Dth and the average vehicle speed is less than a predetermined vehicle speed Vth, the processing circuit 510 determines that the recurrence risk is high, and calculates “3” as the score Sc. When the mileage is less than the predetermined distance Dth and the average vehicle speed is equal to or higher than the predetermined vehicle speed Vth, the processing circuit 510 determines that the recurrence risk is approximately middle, and calculates “2” as the score Sc. That is, when the mileage is less than the predetermined distance Dth, the processing circuit 510 calculates a value larger than when the mileage is equal to or more than the predetermined distance Dth as the score Sc that is an index value.

When the mileage is less than the predetermined distance Dth and the average vehicle speed is less than the predetermined vehicle speed Vth, the processing circuit 510 determines that the recurrence risk is approximately middle, and calculates “2” as the score Sc. When the mileage is equal to or more than the predetermined distance Dth and the average vehicle speed is equal to or higher than the predetermined vehicle speed Vth, the processing circuit 510 determines that the recurrence risk is low, and calculates “1” as the score Sc. That is, when the average vehicle speed is less than the predetermined vehicle speed Vth, the processing circuit 510 calculates a value larger than when the average vehicle speed is equal to or higher than the predetermined vehicle speed Vth as the score Sc that is an index value.

When the score Sc is calculated for each trip for all the acquired travel data, the processing circuit 510 advances the process to step S120. Then, in the process of step S120, the processing circuit 510 calculates the average score Sc_Ave that is an average value of all the calculated scores Sc. The average score Sc_Ave calculated as described above becomes a large value as the number of trips for which the recurrence risk is high increases, and becomes a small value as the number of trips for which the recurrence risk is low increases. That is, the average score Sc_Ave is an index value obtained by reflecting all the history information of the acquired travel data and analyzing the usage mode of the vehicle 10, and indicates the likelihood of recurrence of the overaccumulation.

In the process of next step S130, the processing circuit 510 determines whether the average score Sc_Ave is equal to or larger than a threshold value Sth. The threshold value Sth is a threshold value for determining whether the usage mode of the vehicle 10 is a usage mode in which the overaccumulation is likely to recur or a usage mode in which the overaccumulation is unlikely to recur based on the average score Sc_Ave. That is, the processing circuit 510 determines that the usage mode is a usage mode in which the overaccumulation is likely to recur based on the fact that the average score Sc_Ave is equal to or larger than the threshold value Sth. Then, the processing circuit 510 determines that the usage mode is a usage mode in which the overaccumulation is unlikely to recur based on the fact that the average score Sc_Ave is less than the threshold value Sth.

In short, in this maintenance system, the processes of steps S110 to S130 correspond to the analysis process for analyzing the usage mode of the vehicle 10 based on the history information of the travel data. Specifically, the determination result in which the average score Sc_Ave is less than the threshold value Sth in the process of step S130 corresponds to the analysis result indicating the usage mode in which the overaccumulation is unlikely to recur. On the other hand, the determination result in which the average score Sc_Ave is equal to or larger than the threshold value Sth in the process of step S130 corresponds to the analysis result indicating the usage mode in which the overaccumulation is likely to recur.

When it is determined in the process of step S130 that the average score Sc_Ave is equal to or larger than the threshold value Sth (step S130: YES), the processing circuit 510 advances the process to step S140. Then, in the process of step S140, the processing circuit 510 calculates a maximum time Tx as a value for setting the recommended execution time Tm of the vehicle stop regeneration process. Then, the calculated maximum time Tx is substituted into the recommended execution time Tm.

As shown by the solid line in FIG. 5, the maximum time Tx is set based on the execution time until the accumulated amount of the particulate matter becomes equal to or less than a regeneration completion threshold value PMx by continuation of the vehicle stop regeneration process.

On the other hand, when it is determined in the process of step S130 that the average score Sc_Ave is less than the threshold value Sth (step S130: NO), the processing circuit 510 advances the process to step S150. Then, in the process of step S150, the processing circuit 510 calculates a first time T1 as a value for setting the recommended execution time Tm of the vehicle stop regeneration process. Then, the calculated first time T1 is substituted into the recommended execution time Tm. That is, the processes of steps S140 and S150 are the calculation process for calculating the recommended execution time Tm of the vehicle stop regeneration process to be executed as maintenance.

As shown in FIG. 5, the first time T1 is shorter than the maximum time Tx. When the vehicle stop regeneration process is terminated at the first time T1, the vehicle stop regeneration process is terminated before the accumulated amount decreases to the regeneration completion threshold value PMx. However, when the usage mode is a usage mode in which the overaccumulation is unlikely to recur, the accumulated amount decreases with the subsequent use of the vehicle 10 as shown by the broken line in FIG. 5 through the regeneration process during traveling of the vehicle 10. When the vehicle 10 is in a usage mode in which the overaccumulation is unlikely to recur, the first time T1 is execution time in which the accumulated amount can be reduced to an amount equal to or less than the regeneration completion threshold value PMx through the regeneration process during traveling of the vehicle 10.

When the recommended execution time Tm is calculated through the process of step S140 or step S150, the processing circuit 510 advances the process to step S160. Then, in the process of step S160, the processing circuit 510 transmits screen data for displaying the calculation result of the recommended execution time Tm to the information processing terminal 600. As described above, the screen data is, for example, the HTML data. The information processing terminal 600 displays a web page or other application screens based on the screen data received from the data center 500. Specifically, the display of the information processing terminal 600 displays the recommended execution time Tm calculated in the data center 500. That is, the process of step S160 for transmitting the screen data of the recommended execution time Tm is the display process for displaying the calculated recommended execution time Tm.

When the screen data of the recommended execution time Tm is transmitted through the process of step S160 as described above, the processing circuit 510 ends the series of processes in the routine.

### Operation of Present Embodiment

When the vehicle 10 is used in a usage mode in which the overaccumulation is unlikely to recur, the particulate matter is removed as the vehicle 10 travels thereafter even when the vehicle stop regeneration process is terminated in a state where the particulate matter remains in the particulate filter.

In the above maintenance system, when the analysis result based on the history information of the travel data indicates the usage mode in which the overaccumulation is unlikely to recur (step S130: NO), the recommended execution time Tm is set to the first time T1, and is shorter than the maximum time Tx.

At the maintenance shop, the worker reports in advance the time until the maintenance is completed to the user of the vehicle 10 based on the recommended execution time Tm displayed on the display of the information processing terminal 600. Further, at this time, as a menu for an option for completing the maintenance in a shorter time, the replacement and the like of the particulate filter may be guided.

Then, when the vehicle stop regeneration process is executed, the worker executes the vehicle stop regeneration process until the recommended execution time Tm elapses. Then, when the vehicle stop regeneration process is completed, the worker releases the flag indicating the overaccumulation and ends the maintenance.

### Effect of Present Embodiment

(1) When the recommended execution time Tm is calculated as described above based on the history information of the travel data, the execution time of the vehicle stop regeneration process can be reduced in consideration of the decrease in the particulate matter after the maintenance.

(2) When the recommended execution time Tm is reduced without considering the usage mode of the vehicle 10, the vehicle stop regeneration process is not sufficiently executed, and the accumulated amount reaches the predetermined amount immediately after the maintenance, so that warnings are frequently issued. On the contrary, in the above embodiment, the recommended execution time Tm is calculated based on the history information of the travel data in consideration of the usage mode of the vehicle 10. Therefore, it is possible to suppress the situation in which the warnings are frequently issued due to reduction in the recommended execution time Tm.

(3) When the engine 11 and the exhaust gas control device installed in the exhaust passage 21 are not sufficiently warmed up and travel of the vehicle 10 is completed, the vehicle 10 does not travel in a state where a condition for combusting the particulate matter is satisfied, so that the particulate matter accumulated on the particulate filter does not combust. On the other hand, when the mileage for one trip is long, opportunity for vehicle 10 to travel in a state where the engine 11 and the exhaust gas control device are sufficiently warmed up is increased. Therefore, the particulate matter is likely to combust during traveling of the vehicle 10. That is, when the mileage for one trip is long, it can be said that the recurrence risk of the overaccumulation is low. On the contrary, when the mileage for one trip is short, it can be said that the recurrence risk of the overaccumulation is high.

Therefore, when a configuration is adopted in which when the mileage is less than the predetermined distance Dth as in the above configuration, a value larger than when the mileage is equal to or larger than the predetermined distance Dth is calculated as the score Sc, the recurrence risk of the overaccumulation can be set as an index. Information on the mileage for one trip can be reflected in the analysis result of the usage mode of the vehicle 10.

(4) The engine 11 is likely to be operated with a high load as the vehicle speed is high. When the engine 11 is operated with a high load, the temperature of the exhaust gas is high, so that the temperature of the particulate filter and the temperature of the exhaust gas control device are high. Therefore, the particulate matter accumulated on the particulate filter easily combusts. That is, when the average vehicle speed for one trip is high, it can be said that the recurrence risk of the overaccumulation is low. On the contrary, when the average vehicle speed for one trip is low, it can be said that the recurrence risk of the overaccumulation is high.

Therefore, when a configuration is adopted in which when the average vehicle speed is less than the predetermined vehicle speed Vth as in the above configuration, a value larger than when the average vehicle speed is equal to or higher than the predetermined vehicle speed Vth is calculated as the score Sc, the recurrence risk of the overaccumulation can be set as an index. Information on the average vehicle speed for one trip can be reflected in the analysis result of the usage mode of the vehicle 10.

The present embodiment can be modified and implemented as follows. The present embodiment and modification examples described below may be carried out in combination of each other within a technically consistent range.
The content of the travel data acquired for performing the analysis process may be changed as appropriate. For example, the travel data stored in the storage device 520 may include the average temperature of the particulate filter for one trip. Then, in this case, when the average temperature is less than the predetermined temperature, the processing circuit 510 of the maintenance system calculates, in the analysis process, a value larger than when the average temperature is equal to or higher than the predetermined temperature as the score Sc.

The particulate matter easily combusts as the temperature of the particulate filter is high. Further, the more the particulate matter combusts during traveling of the vehicle, the higher the temperature of the particulate filter becomes. That is, when the average temperature of the particulate filter for one trip is high, it can be said that the recurrence risk of the overaccumulation is low. On the contrary, when the average temperature for one trip is low, it can be said that the recurrence risk of the overaccumulation is high.

Therefore, even when a configuration is adopted in which when the average temperature of the particulate filter is less than the predetermined temperature as in the above configuration, a value larger than when the average temperature is equal to or higher than the predetermined temperature is calculated as the index value, the recurrence risk of the overaccumulation can be set as an index. When the score Sc is calculated using the average temperature of the particulate filter in addition to the average vehicle speed and the mileage, the score Sc can be calculated based on a more multi-faceted evaluation. Therefore, more accurate analysis can be performed.

Further, the travel data stored in the storage device 520 may include the coolant temperature at the time of starting the engine 11. Then, in this case, when the coolant temperature is less than the predetermined temperature, the processing circuit 510 of the maintenance system calculates, in the analysis process, a value larger than when the coolant temperature is equal to or higher than the predetermined coolant temperature as the score Sc.

The engine 11 is started from a state close to a state in which the warm-up of the engine 11 is completed, as the coolant temperature at the time of starting the engine 11 is high, so that opportunity for vehicle 10 to travel in a state where the warm-up of the engine 11 is completed tends to increase. Further, the higher the coolant temperature at the time of starting the engine 11, the higher the possibility that the next trip is started before the engine 11 is completely cooled and the vehicle 10 travels in a state where the warm-up of the engine 11 is completed.

The more frequently the vehicle travels in a state in which the warm-up is completed, the more easily the particulate matter combusts during traveling of the vehicle. That is, when the coolant temperature at the time of starting the engine 11 is high, it can be said that the recurrence risk of the overaccumulation is low. On the contrary, when the coolant temperature at the time of starting the engine 11 is low, it can be said that the recurrence risk of the overaccumulation is high.

Therefore, even when a configuration is adopted in which when the coolant temperature at the time of starting the engine 11 is less than the predetermined coolant temperature as in the above configuration, a value larger than when the coolant temperature is equal to or higher than the predetermined coolant temperature is calculated as an index value, the recurrence risk of the overaccumulation can be set as an index. When the score Sc is calculated using the coolant temperature at the time of starting the engine 11 in addition to the average vehicle speed and the mileage, the score Sc can be calculated based on a more multi-faceted evaluation. Therefore, more accurate analysis can be performed.

All of the average vehicle speed, the mileage, the average temperature of the particulate filter, and the coolant temperature at the time of starting the engine may be used. Further, each of these values can be used independently to calculate the score Sc.

Further, as a calculation mode of the score Sc, the embodiment in which a value is selectively selected in comparison with a threshold value is shown as an example, but the calculation mode of the score Sc is not limited to such a mode. For example, a mode can be adopted in which a small value is calculated as the score Sc as the average vehicle speed is high, and a small value is calculated as the score Sc as the mileage is long.
In the above embodiment, the example is shown in which the value of the recommended execution time Tm to be calculated is switched depending on whether the average score Sc_Ave is equal to or larger than the threshold value Sth or the average score Sc_Ave is less than the threshold value Sth. Instead of such a configuration, a mode can be adopted in which in the analysis process, the average score Sc_Ave is output as the analysis result, and in the calculation process, the short recommended execution time Tm is calculated as the average score Sc_Ave is small.

In this case, the execution time of the vehicle stop regeneration process can be reduced according to the difficulty of recurrence of the overaccumulation.
Although the example is shown in which the maintenance system is embodied as the data center 500, the configuration is not limited to this. The maintenance system may execute the acquisition process, the analysis process, the calculation process, and the display process.

For example, it is also possible to download the history information of the travel data of the vehicle 10 from the data center 500 and execute the analysis process, the calculation process, and the display process in the information processing terminal 600. In this case, it is not necessary to transmit the screen data in the display process, and in the display process, the calculated recommended execution time Tm may be displayed on the display. In this case, the information processing terminal 600 corresponds to the maintenance system.

Further, the information processing terminal 600 and the data center 500 may be configured to execute the same process as the series of processes in the above embodiment. That is, the maintenance system may be composed of the information processing terminal 600 and the data center 500. In this case, for example, the data center 500 executes steps S100 to S120 described with reference to FIG. 3, that is, the processes up to the calculation of the average score Sc_Ave. Then, the information processing terminal 600 executes the processes from step S130, that is, the calculation process for calculating the recommended execution time Tm according to the result of the analysis process. Further, for example, the data center 500 may execute the processes up to the calculation of the score Sc for each trip in step S110, and the information processing terminal 600 may execute the processes from step S120.

The maintenance system can also be mounted on the vehicle 10. For example, in this case, as shown by the broken line in FIG. 2, a storage device 90 is provided in the vehicle 10 to store the travel data of the vehicle 10. Then, the control device 150 executes a routine similar to the routine of the above embodiment based on the history information of the travel data stored in the storage device 90. Then, the calculated recommended execution time Tm may be displayed on the display of the driver's seat of the vehicle 10.

When the data center 500 or the information processing terminal 600 is used as a maintenance system, and the storage device 90 is provided in the vehicle 10 as described above, the data center 500 or the information processing terminal 600 may acquire the history information of the travel data from the vehicle 10.
The regeneration process as the maintenance may not be the vehicle stop regeneration process, but a travel regeneration process in which the particulate matter is combusted by the regeneration process during traveling of the vehicle driven by the worker. In this case, the maintenance system calculates the recommended execution time suitable for the travel regeneration process based on the analysis result of the travel mode of the vehicle 10. Both the recommended execution time of the vehicle stop regeneration process and the recommended execution time of the travel regeneration process may be calculated.
In the above embodiment, in the acquisition process, the history information in the period from the time when the regeneration process as maintenance was executed for the target vehicle 10 previous time to the time when the accumulated amount is determined as the overaccumulation this time is acquired. On the other hand, the history information on the predetermined number of trips until it is determined as the overaccumulation this time may be acquired. In this case, in the analysis process, for example, the score Sc for each trip is calculated based on the travel data for the acquired predetermined number of trips. Then, it is determined whether the integrated value of all the calculated scores Sc is equal to or higher than the threshold value, and the recommended execution time Tm is calculated according to the result. That is, when the integrated value of the scores Sc is equal to or higher than the threshold value, the maximum time Tx is calculated as the value for setting the recommended execution time Tm. On the other hand, when the integrated value of the scores Sc is less than the threshold value, the first time T1 is calculated as the value for setting the recommended execution time Tm. The fact that the integrated value of the scores Sc for the predetermined number of trips is less than the threshold value means that the average value of the scores Sc for the predetermined number of trips is less than a specific level. Therefore, such a mode is also one of the modes for determining that the average value of the index values is less than the threshold value.
In the above embodiment, the data center 500 that is the maintenance system includes the processing circuit 510 and the storage device 520 to execute software processing. However, this is only an example. For example, the maintenance system may include a dedicated hardware circuit (for example, an application-specific integrated circuit (ASIC), etc.) that processes at least part of the software processing executed in the above embodiment. That is, the maintenance system may have any of the following configurations (a) to (c). (a) The maintenance system includes a processing circuit that executes all processes according to a program, and a storage device that stores the program. That is, the maintenance system includes a software execution device. (b) The maintenance system includes a processing circuit that executes a part of processes according to a program, and a storage device. In addition, the maintenance system includes a dedicated hardware circuit to execute the rest of the processes. (c) The maintenance system includes a dedicated hardware circuit that executes all processes. Here, there may be a plurality of software processing circuits and/or dedicated hardware circuits. That is, the processes can be executed by a processing circuitry including at least one of one or more software processing circuits and one or more dedicated hardware circuits. The storage device that stores the program, that is, a computer-readable medium includes any available medium accessible by a general purpose computer or a dedicated computer.
Although the example is shown in which the engine 11 of the vehicle 10 is an in-line four-cylinder engine having four cylinders, the present disclosure is not limited to this. That is, the engine 11 is not limited to the four-cylinder engine. Further, the engine 11 may be a V-type engine, a horizontally opposed engine, or a W-type engine in which an exhaust gas control device is provided for each bank. In this case, the stop control may be established such that the fuel supply to at least one cylinder in each bank is stopped during one cycle. This makes it possible to send sufficient oxygen to the exhaust gas control device of each bank of the V-type engine and the like.
The example is shown in which the upstream exhaust gas control device 22 and the downstream exhaust gas control device 23 are provided, and the downstream exhaust gas control device 23 serves as the particulate filter. The configuration of the exhaust gas control system of the engine 11 is not limited to such a configuration. When the maintenance system is at least a maintenance system for a vehicle equipped with the engine 11 including the particulate filter, the same configuration as that of the above embodiment can be applied.
The configuration of the powertrain in the vehicle 10 is not limited to the configuration shown in FIG. 2 as an example. For example, the regeneration process can be executed even in a vehicle equipped only with the engine 11 as a driving force source, not a hybrid electric vehicle equipped with a motor. Therefore, the maintenance system of the above embodiment can be applied to the vehicle equipped only with the engine 11, as in the vehicle 10.

What is claimed is:

1. A vehicle maintenance system for a vehicle including a function for determining overaccumulation when an accumulated amount of particulate matter in a particulate filter provided in an exhaust passage of an engine becomes equal to or larger than a predetermined amount and encouraging a user to maintain the vehicle to eliminate a state of the overaccumulation, the vehicle maintenance system comprising a processing circuit for executing an acquisition process for acquiring travel data of the vehicle, a calculation process for calculating recommended execution time of a regeneration process to be executed as maintenance, and a display process for displaying the calculated recommended execution time, wherein:
the processing circuit executes an analysis process for analyzing a usage mode of the vehicle based on history information of the travel data acquired through the acquisition process; and
in the calculation process, the processing circuit refers to an analysis result of the analysis process, and when the analysis result indicates a usage mode in which the overaccumulation is unlikely to recur, the processing circuit calculates the recommended execution time shorter than when the analysis result does not indicate the usage mode in which the overaccumulation is unlikely to recur.

2. The vehicle maintenance system according to claim 1, wherein in the analysis process, the processing circuit calculates index values of recurrence risk of the overaccumulation for each trip based on the history information of the travel data, and when an average value of the index values is less than a threshold value, the processing circuit outputs the analysis result indicating the usage mode in which the overaccumulation is unlikely to recur.

3. The vehicle maintenance system according to claim 1, wherein:
in the analysis process, the processing circuit calculates index values of recurrence risk of the overaccumulation for each trip based on the history information of the travel data, and outputs an average value of the index values as the analysis result; and
in the calculation process, the processing circuit calculates the recommended execution time that is shorter as the average value is small.

4. The vehicle maintenance system according to claim 2, wherein:
the travel data includes mileage for one trip; and
the processing circuit calculates, in the analysis process, a value larger than when the mileage is equal to or more than a predetermined distance as an index value, when the mileage is less than the predetermined distance.

5. The vehicle maintenance system according to claim 2, wherein:
the travel data includes an average vehicle speed for one trip; and
the processing circuit calculates, in the analysis process, a value larger than when the average vehicle speed is equal to or higher than a predetermined vehicle speed as an index value, when the average vehicle speed is less than the predetermined vehicle speed.

6. The vehicle maintenance system according to claim 2, wherein:
the travel data includes an average temperature of the particulate filter for one trip; and
the processing circuit calculates, in the analysis process, a value larger than when the average temperature is equal to or higher than a predetermined temperature as an index value, when the average temperature is less than the predetermined temperature.

7. The vehicle maintenance system according to claim 2, wherein:
the travel data includes a coolant temperature when the engine is started; and
the processing circuit calculates, in the analysis process, a value larger than when the coolant temperature is equal to or higher than a predetermined coolant temperature as an index value, when the coolant temperature is less than the predetermined coolant temperature.
